(19) United States
(12) Patent Application Publication
(10) Pub. No.: US 2003/0154607 A1
(43) Pub. Date: Aug. 21, 2003

(54) Vegetable product shredding apparatus

(76) Inventor: Stephane Hamptaux, St-Thuribe (CA)

Correspondence Address: Akerman Senterfitt & Eidson, Post Office Box 3188, West Palm Beach, FL, 33402-3188, US

(21) Appl. No.: 10/220,105

(22) PCT Filed: Feb. 28, 2001
(86) PCT No.: PCT/BE01/00030

(30) Foreign Application Priority Data
Feb. 28, 2000 (BE) 2000/0157

(51) Int. Cl. B26B 13/00

(52) U.S. Cl. 30/265

(57) ABSTRACT

The invention concerns a vegetable product shredding apparatus comprising means (5) supplying vegetable products (20), a part ejecting (7) shredded vegetable products and an intermediate chamber (6) comprising a rotor (12) secured to several blades (10, 11). The rotor has several blades (12) in a plane perpendicular or inclined relative to the rotor pin (2) and at least another blade (11) offset about the rotor pin (2) and parallel thereto. The blades (10) are arranged into at least two rows of blades. Preferably, one row of blades (10a) is inclined in one direction and another row of blades (10b) is inclined in the other direction.

The present invention is concerned with an apparatus for shredding woody vegetable products.

This type of apparatus is used to cut vegetable products into homogenous particles in order to significantly reduce the initial volume thereof. The product obtained at first from crown, brushwood or the like is transformed into recyclable material that can be readily used, for instance, in agricultural or forestry applications for regenerating and fertilizing soils.

Similar devices are well known. They generally consist of self-propelled or towed mobile frames and they are often provided with means for supplying vegetable products, with a shredding chamber and with means for discharging the shredded pieces.

The shredding chamber generally comprises a blade system mounted on a rotating shaft (rotor) and a counter blade also known as a breaker plate. The shaft of the rotor is preferably driven by a motor.

The object of the present invention is to considerably reduce the dimensions and the power of the machine while, at the same time, keeping and even increasing its efficiency.

It is very important to allow this type of apparatus to operate with a minimum of energy, particularly since it is often used in isolated areas. The present invention is particularly useful in developing countries where the energy consumption must be reduced to a minimum. In other places, the apparatus keeps all its particularity of increased power.

According to a preferred embodiment, one characteristic of the invention is that the apparatus does not necessitate any auxiliary mechanical assistance for its feeding with green products.

A significant reduction in the power needed to grind the vegetable products has been noted while using the present bladed device.

This reduction can reach a value of 20 to 30% as compared to conventional devices.

The device, according to the present invention, combines two types ofdistinct blades: splitting blades hereinafter referred to as “triangular blades ” and cutting and traction blades hereinafter referred to as “straight blades”.

More particularly, the invention consists in the shape and the special disposition of a blade system mounted to a rotating shaft.

This disposition permits realizing the following functions:

self feeding of the shredder without the need for an external system to ensure continuous feeding of the machine,

grinding or shredding facilitated by a combined effect of progressive splitting (triangular shape of the blades) and cutting (logs already roughed down and split before the straight blade starts to cut and pull on the logs),

discharge of the shredded product without any external system.

The system is composed of two distinct parts (see figures):

a rotating part (2200 to 2800 rpm) named. rotor. This part comprises a shaft perpendicular to a feeding direction of the green products, on which are arranged two types of blades: triangular blades and straight blades,

a part termed “counter blade” which is adjustable (it is this part that will determine the particle size of the finished product according to its setting). The counter blade is bolted to the frame.

The axis of the shaft on which the triangular and straight blades are mounted is thus perpendicular to the advancing direction of the products to be shredded and the counter blade is mounted parallel to the rotor with a spacing X (0.5 and 3 mm).

The products to be shredded are introduced into the feed launder in a coventional manner. The base of the products (for instance the branches) is first longitudinally introduced in the direction of the fibers.

As indicated hereinbefore, shredding of the product is obtained by the combination of two cutting systems, each realized by a distinct type of knife: “triangular” splitting knives and straight blades.

The two types of knives are preferably symmetrically distributed on the rotor of the shredder. A counter blade or breaker plate forming the stator of the cutting system is provided to cut the vegetable products to the desired

In the present description, the term triangular knife is intended to mean knife or blade presenting, during the cutting operation, a slanted cutting edge providing for the progressive penetration of the knife into the material to be cut. This knife will have a decreasing cutting width towards its distal end with respect to the shaft of the rotor. The knife could, for instance, consist of a triangular knife having a trapezoidal or isosceles trapezoid profile. The tips of the blades are thus preferably oriented towards the exterior of the rotor.

The knives are generally interchangeable and thus secured by known means to one or more support means provided on the rotating shaft.

The support means are composed, for instance, of plates perpendicular to the shaft and rigidly secured to the shaft, eventually by means of hand plates or flanges. The rotor is formed by the support means, the shaft and the knives.

There can be a plurality of rows of triangular knives arranged about the shaft of the rotor.

The plane of the blade can be perpendicular to the axis of the rotor or inclined at a given angle, comprised preferably between 10 to 45°, and more preferably between 30 to 35°, depending on the green product to be treated and the desired finished product. The planes of the blades will stay vertical relative to the plane formed by the shaft and the supply axis of the vegetable products.

In the case of the inclined triangular knives, two groups of triangular knives are preferably arranged in an opposed manner so that the incline of the plane of the knife will be oriented towards the right relative to the advancing direction for a group of knives and towards the left for the following group. This provides for the incoming wood to be cut slantwise on both sides thereof, thereby reducing the wood section to be cut by the straight blades.

Preferably, the number of knives and their slant is such that their cutting zones are overlaid (overlap of the space swept by the blades). In this case, there is thus no space that is not swept by the knives. Each triangular knife works on a given width. The knives being slightly overlapped, the waste to be shredded necessarily comes into contact with the knives, which will ensure their splitting.

In the case of triangular knives placed perpendicular to the axis of rotation, the free space between the knives is reduced to a minimum in order to obtain the best result (grating of the finished product).

The angle of the incline of the cutting edges of the triangular knives ensures a progressive penetration of the cutting edge into the material to be shredded, thereby reducing the level of energy required to perform the shredding operation.

The triangular knives act as the thin ends of wedges and thereby ensure splitting of the wood. The counter blade or the breaking plate fixed to the frame of the shredder, ensures the fixed position of the vegetable products before the cutting operation.

According to the invention, in addition to the knife system mentioned hereinbefore, there is provided at least one other knife system constituted by at least one knife secured to the rotor and having a blade, i.e. a cutting plane, parallel to said rotor.

Preferably, the knife extends on a substantial portion of the length of the rotating shaft so as to cover all the available cutting width of the apparatus. The knife is provided in the form of rigid blades arranged parallel to the axis of rotation of the shredder such as in a buzz planer. The blades are secured to the rotor and distributed about the circumference thereof. The smallest machines, developed according to a simplified embodiment of the present invention, are provided with two blades staggered by 180°. These knives cut the branches transversally and cause the ingestion of the products to be shredded into the machine, thereby obviating the need for a driving system for feeding material into the shredder and/or discharging shredded material therefrom.

The advancement of the product to be shredded is ensured by the relative position of the counter blade with respect to the rotor shaft. To this end, the plane of the counter blade must necessarily pass under the rotating shaft of the rotor. The more significant the gap, the more significant will be the traction effect on the branches.

The discharge of the shredded product is ensured by the sweeping effect obtained from the rapid rotation of the straight blades.

The two groups of blades preferably cover all the width of the machine, while leaving a gap of, for instance, only 2 to 3 mm on each side. This results in an optimal shredding of the vegetable products. The straight blades arranged parallel to a rotor shaft and rigidly secured thereto cut transversally, at a given length, the wood which has already been processed by the triangular knife. This length is set as a function of the rotating speed of the rotor and of the advancing speed of the vegetable products. Theoretically, split wood logs are obtained. In this way, the energy provided by the motor is used in an optimal manner.

The branches that can be shredded by the apparatus of the present invention could have a diameter of about 15 cm and even more for certain types of wood. The goal is to give worth to vegetable products that would otherwise be regarded as waste. Vegetable products of greater diameter have a utility in most cases (fuel wood, wood charcoal, lumber). However, it is possible, with the present invention, to use the present principles and to increase the diameter of the rotor and the number of rows of knives (triangular and straight). In this case, this type of rotor can be used for other applications (paper pulp, wafer board panels).

The shredding system provides for the cutting of ligneous vegetable products as well as semi-ligneous vegetable products, such as corn plants, tropical grass, sugar cane. Freshly-cut products can be shredded with their leaves still on, which does not affect the functioning of the apparatus. This is more significant in tropical zones where the leaf surface of the plants is, in most instances, persistent.

The invention will be better understood with reference to the accompanying drawings, showing by way of illustration a preferred embodiment of the ivention, and in which:

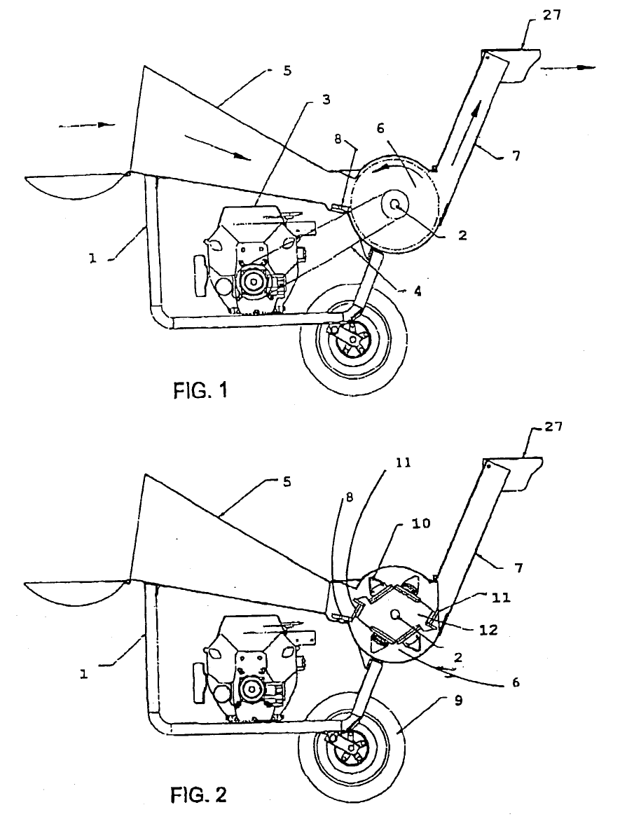

FIG. 1 shows a general view of a device in accordance with the present invention,

FIG. 2 shows the device shown in FIG. 1 in a more detailed manner by illustrating the shredding chamber of the device,

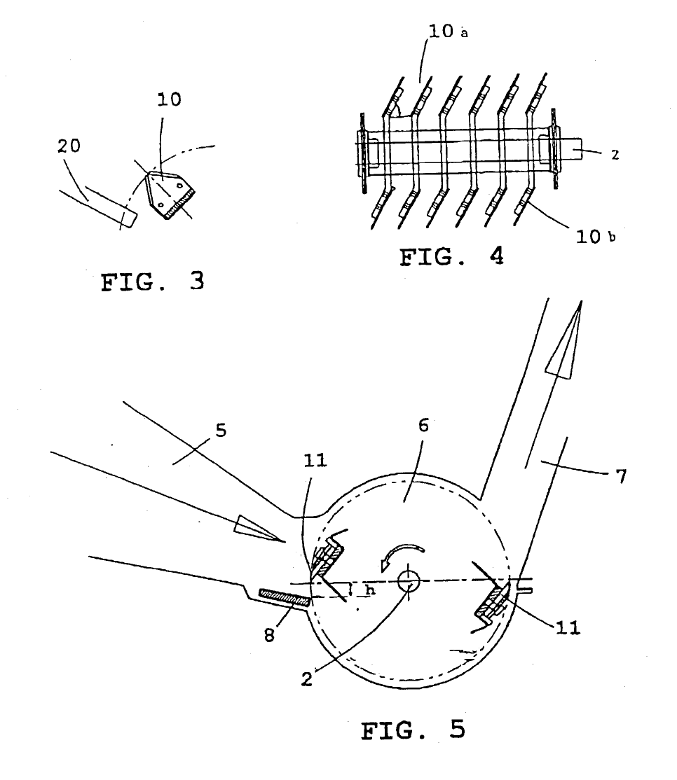

FIGS. 3 to 5 show the shredding principle of the present invention,

FIG. 4 represents a simple configuration of triangular knives about the shaft,

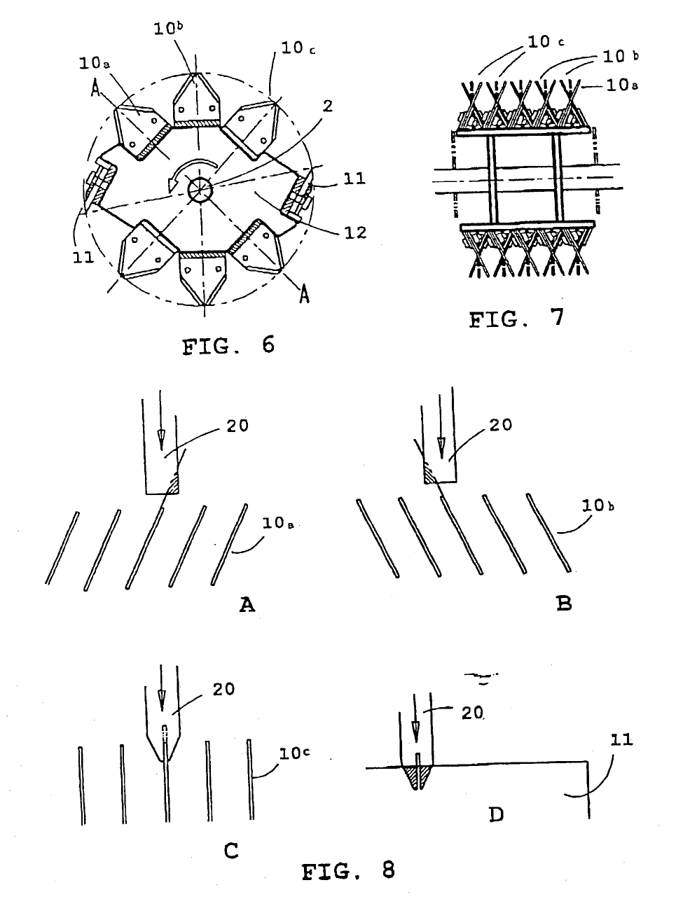

FIG. 6 is a side view of the complete cutting system,

FIG. 7 shows a more complex configuration of the knives in which there are three positions of the triangular knives,

FIG. 8 shows the shredding steps according to an embodiment of the present invention,

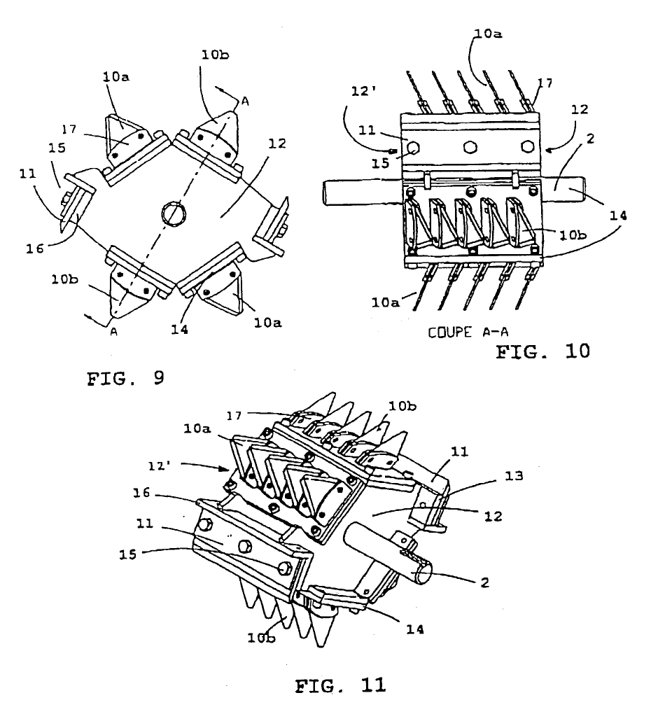

FIGS. 9, 10 and 11 are respectively side, section and perspective views of a variant of the present invention comprising two rows of triangular knives.

FIG. 1 is a side view of a device in accordance with the present invention. The device comprises a frame 1 carrying a cylindrical or hemi-cylindrical chamber 6, the axis of which is provided with a rotating shaft 2 driven by a motor 3 via a belt 4. The vegetable products are introduced at 5 and discharged at 7 after having been shredded in the chamber 6. The device further comprises a counter blade 8. The discharge pipe 7 is provided with a deflector 27. The frame is mounted on wheels 9 in order to allow the device to be, for instance, towed behind a motor vehicle.

FIG. 2 illustrates, in a more detailed way, the shredding chamber 6 of said device. It can be seen that the rotor in the chamber 6 comprises two types of knives 10 and 11 mounted on flanges 12 which are preferably welded to the shaft 2. Two rows of triangular knives 10 are disposed on opposed sides of the shaft, staggered by 90° with respect to the straight knives 11.

FIG. 3 represents in a schematic way the action of a blade 10 on an element to be shredded 20.

FIG. 4 represents a simple configuration of the triangular knives 10 about the shaft. There are two rows of blades 1Oa and 1Ob, the knives or blades being oriented in one direction and then in another direction after a rotation of 180°.

FIG. 5 illustrates the operation of the straight knives 11 with the counter blade 8. The plane of the counter blade must absolutely pass under the axis of rotation of the rotor. The more significant the gap (h), the more significant the traction effect will be on the branches.

FIG. 6 is a view in profile of the complete rotor according to an embodiment of the present invention. There are provided a support flange 12 perpendicular and secured to the shaft 2 of the rotor and also three types of triangular blades.

FIG. 7 is a front cross section view illustrating the three types of blades shown in FIG. 6.

As shown in FIG. 6, four different types of blades or knives can be distributed about the shaft 2, namely, the triangular blades 10a which are slanted on one side, the blades 10b, which are slanted on the opposite side, the triangular blades 10c perpendicular to the axis and the transversal cutting straight blades 11.

The shredding operation is effected in four stages schematically shown in FIG. 8 for an elongated vegetable product 20: a longitudinal slanted cut A, an opposed longitudinal slanted cut B, a straight longitudinal cut C and a transversal cut D.

FIG. 9 illustrates another embodiment of a six-blade rotor including two types of triangular blades 10a, 10b and one type of straight blade 11, the FIG. 10 being a section taken along line A-A in FIG. 9, and FIG. 11 being a perspective view.

In this example, the rotor 2 includes, on each side, two flanges 12 and 12′ extending perpendicularly to the shaft of the rotor and secured thereto, as by welding, for receiving plates 13 and 16. The plates 13 and 16 are welded to the flanges 12 and 12′ and are parallel to the shaft 2. These plates serve as support for the straight blades or as supports for oblique blades 14 which can, for instance, be secured thereto with bolts 15. The triangular blades 10a, 10b are secured by bolts or screws to wings 17 secured to the support plates 13.

1) A vegetable product shredding apparatus comprising means (5) supplying vegetable products (20), a part ejecting (7) shredded vegetable products and an intermediate chamber (6) comprising a rotor (12) secured to several blades (10, 11), characterized in that at least one blade (10) has a perpendicular or inclined plane with respect to the shaft (2) of the rotor and at least one other blade (11) offset about the shaft (2) of the rotor and parallel thereto.

2) An apparatus according to claim 1 characterized in that there is provided a plurality of blades (10) arranged in at least two rows of blades.

3) An apparatus according to claim 1 or claim 2, characterized in that there is provided a plurality of blades (10) arranged in at least two rows of blades; one row of blades (10a) being inclined in one direction and another row of blades (10b) being inclined in the other direction.

4) An apparatus according to claim 3, wherein the other row is the next row.

5) An apparatus according to any one of the preceding claims, comprising about the shaft (2) of the rotor six blades or rows of blades comprising two opposed straight blades (11), spaced on opposed sides by two rows of blades (10), one of the rows being inclined in one direction and the other row in the other direction.

6) An apparatus according to any one of claims 1 to 4, comprising about the shaft (2) of the rotor eight blades or rows of blades comprising two opposed straight blades (11), spaced on opposed sides by three rows of blades (10), one of said rows being, with respect to the shaft (2) of the rotor, inclined blades in one direction (10a), the next row being inclined in the other direction (10b) and the next row presenting a row of perpendicular blades (10c).

7) An apparatus according to any one of the preceding claims, in which the blades (10) have a triangular or trapezoidal cutting profile.

8) An apparatus according to any one of the preceding claims, in which the shredding of the vegetable products is obtained by the cooperation between the blades (10, 11) of the rotor and at least one counter blade (8).

9) An apparatus according to any of the preceding claims, in which the slant of the inclined blade(s) with respect to the shaft of the rotor is inferior to 45° and preferably ranges between 20 to 35°.

10) A method of cutting elongated vegetable. products, consisting in a slanted cut of one extremity of one side, and then on the other, followed by a transversal cut.

11) A method according to claim 10, consisting in a slanted cut of one extremity of one side, and then the other side, and of a longitudinal splitting, followed by a transversal cut.
